(19) United States
(12) Patent Application Publication
(10) Pub. No.: US 2019/0098882 A1
(43) Pub. Date: Apr. 4, 2019

(54) ADAPTER SYSTEM THAT TRANSFORMS A BLOWGUN INTO A FISHING BLOWGUN

(71) Applicant: John Richard Emert, Melbourne, FL (US)

(72) Inventor: John Richard Emert, Melbourne, FL (US)

(21) Appl. No.: 16/112,905

(22) Filed: Aug. 27, 2018

Related U.S. Application Data
(60) Provisional application No. 62/565,872, filed on Sep. 29, 2017.

(51) Int. Cl. A01K 81/00; F41B 1/00

(52) U.S. Cl. CPC A01K 81/00; F41B 1/00

(57) ABSTRACT

An adapter system that transforms a blowgun into a fishing blowgun is provided. The fishing blowgun adapter system includes a reel mounting system which is used to selectively secure a fishing reel along a barrel of the blowgun. The present invention also embodies a plurality of fishing line eye guides spaced apart the barrel from largest to smallest at or near the distal end of the blowgun. Furthermore, using the fishing line eye guides instead of a fishing rod (prior art) eliminates the danger of spring-loaded backlashes of earlier makeshift solutions. Once the fishing blowgun adapter system has been operatively associated with the blowgun, the transformation into a fishing blowgun is complete.

### CROSS-REFERENCE TO RELATED APPLICATION

This application claims the benefit of priority of U.S. provisional application No. 62/565,872, filed 29 Sep. 2017, the contents of which are herein incorporated by reference.

### BACKGROUND OF THE INVENTION

The present invention relates to fishing accessories and, more particularly, to an adapter system that transforms a blowgun into a fishing blowgun.

The “fishing blowguns” that you can find online in images or in videos are makeshift endeavors wherein the fishing rod and fishing reel are secured to the blowgun in a way where it would be difficult and time consuming to arrange, adjust, and/or disassemble. Such makeshift approaches typically include securing the fishing rod and the fishing reel together with duct tape, zip ties, circle clamps, etc. Furthermore, utilizing a fishing rod is dangerous because of the spring-loaded backlashes that occur when fighting a fish can cause the dart to become dislodged (or “unbarbed”). There is currently no blowgun to fishing blowgun adapter systems specifically adapted to efficiently and advantageously transforms a blowgun into a fishing blowgun.

As can be seen, there is a need for adapter system that transforms a blowgun into a fishing blowgun that enables for an efficient transformation by engaging a barrel of a preselected blowgun. Conversely, the fishing blowgun adapter system can be disengaged in an easy and timely manner which transforms the fishing blowgun back to its original blowgun state.

The fishing blowgun adapter system provides four components that all slide onto the barrel of the existing blowgun. The first part that slides on is a reel mounting system which is used to secure a fishing reel to the blowgun. Thereby, enabling selective adjustment of the fishing reel portion relative to the blowgun portion. The other three components are a series of spaced apart fishing line eye guides arranged in a proper order from largest nearest the reel mounting system to smallest at or near the distal end of the barrel of the blowgun. Furthermore, using the fishing line eye guides instead of a fishing rod (prior art) eliminates the danger of spring-loaded backlashes of earlier makeshift solutions. Once all parts of the fishing blowgun adapter system have been placed in proper position along the barrel, the blowgun has successfully been transformed into a fishing blowgun that will be used for blowgun fishing.

### SUMMARY OF THE INVENTION

In one aspect of the present invention, a fishing blowgun adapter system, includes a reel mounting system for connecting a fishing reel to a blowgun in a locking engagement; and a plurality of fishing line eye guides for attaching to the blowgun in a spaced apart arrangement there along.

In another aspect of the present invention, the fishing blowgun adapter system, includes a reel mounting system for connecting a fishing reel to a blowgun in a locking engagement; the reel mounting system providing a central tubular portion and two opposing end caps, wherein the central tubular portion provides exterior circumferential threading and the two end caps ach provide interior circumferential threading dimensioned to mate with the exterior circumferential threading, and wherein each end cap provides a through hole coextensive with a lumen of the central tubular portion; and a longitudinal cut along a length of the central tubular portion; the fishing blowgun adapter system further including a first, a second, and a third fishing line eye guide for attaching to the blowgun in a spaced apart arrangement there along; each fishing line eye guides includes a barrel loop and a line loop interconnected by a neck portion, wherein each barrel loop removably attaches to the blowgun, wherein each line loop has a different diameter, wherein each neck portion has a different length; and the first, second, and third fishing line eye guides are attached along the blowgun from largest to smallest loop line diameter, respectively, and from largest to smallest neck portion length diameter, respectively, extending from the reel mounting system to a distal end of the blowgun.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is a top exploded perspective view of an exemplary embodiment of the present invention;

FIG. 3 is a side orthogonal detail view of an exemplary embodiment of the present invention;

FIG. 4 is a front perspective view of an exemplary embodiment of the present invention;

FIG. 5 is a front detail perspective view of an exemplary embodiment of the present invention; and

FIG. 6 is a front perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an adapter system that transforms a blowgun into a fishing blowgun. The fishing blowgun adapter system provides a reel mounting system which is used to selectively secure a fishing reel along a barrel of the blowgun. The present invention also embodies a plurality of fishing line eye guides spaced apart the barrel from largest to smallest at or near the distal end of the blowgun. Furthermore, using the fishing line eye guides instead of a fishing rod (prior art) eliminates the danger of spring-loaded backlashes of earlier makeshift solutions. Once the fishing blowgun adapter system has been operatively associated with the blowgun, the transformation into a fishing blowgun is complete.

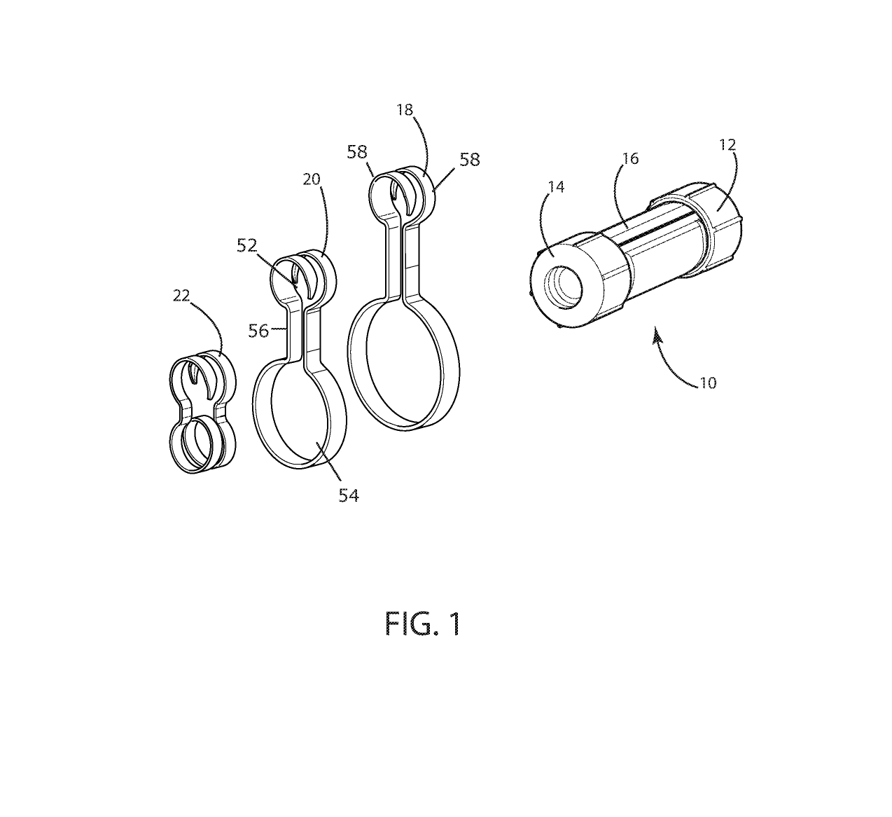

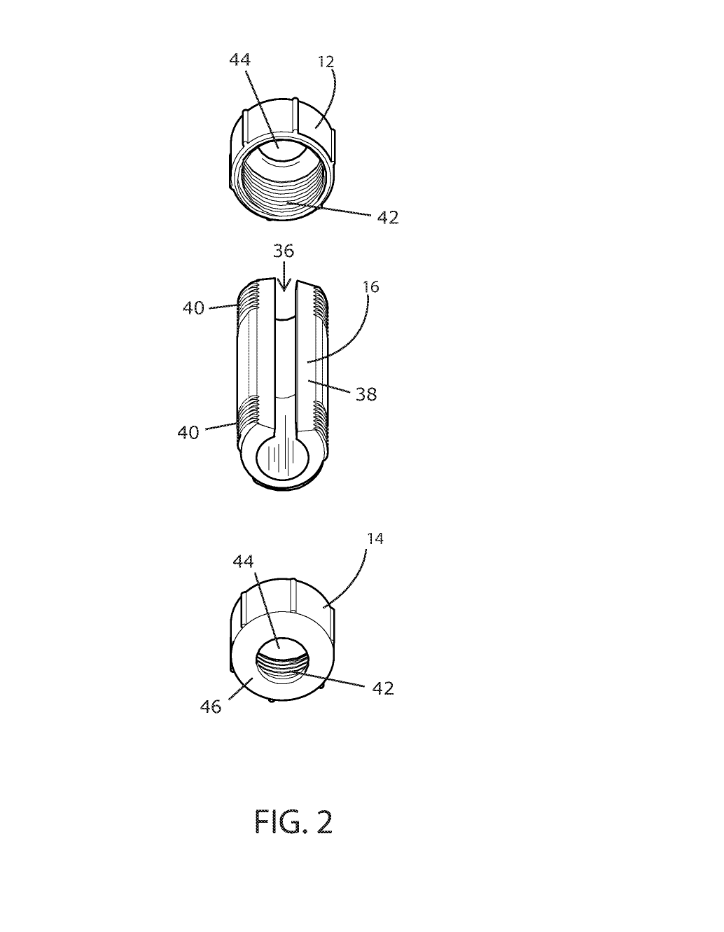

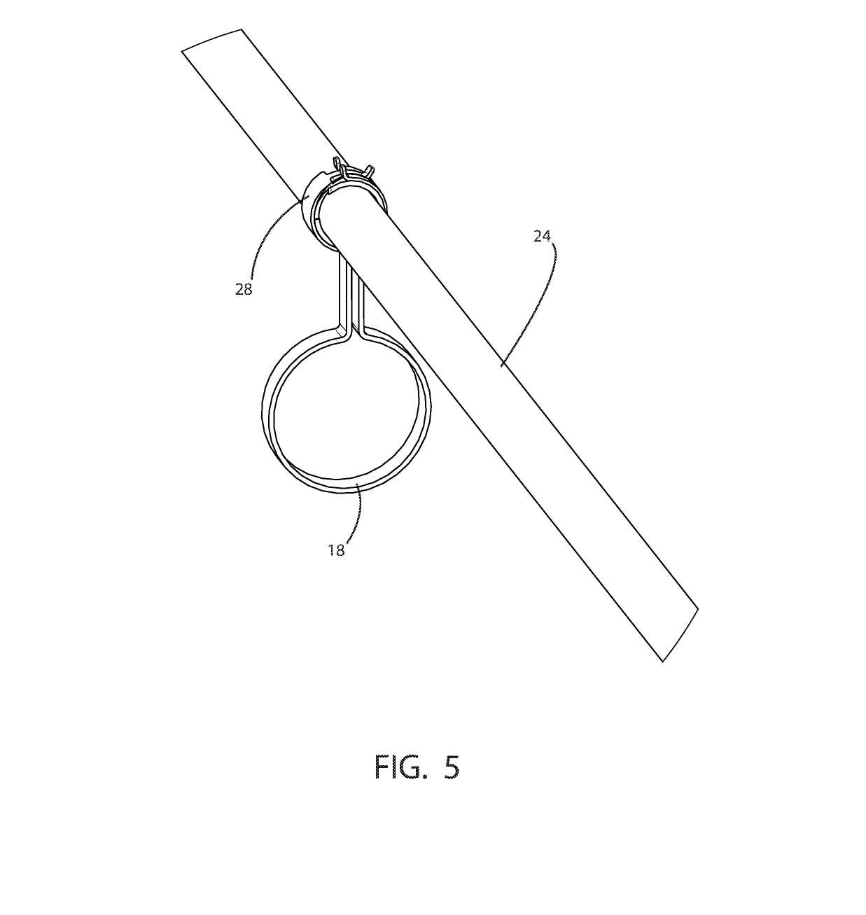

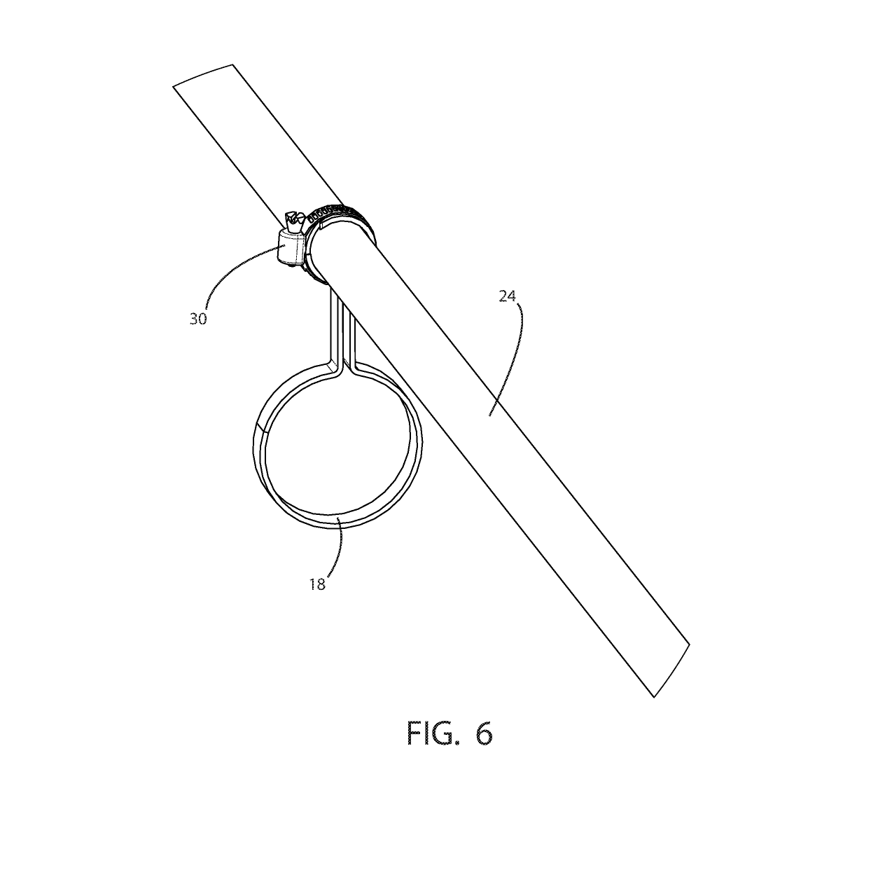

Referring to FIGS. 1 through 6, the present invention may include a fishing blowgun adapter system 100 embodying a fishing reel mounting element 10, a first fishing line eye guide 18, a second fishing line eye guide 20, and a third fishing line eye guide 22. The first fishing line eye guide 18 being larger than the second fishing line eye guide 20, and the second fishing line eye guide 20 larger than the third fishing line eye guide 22. The components of the fishing blowgun adapter system 100 may be made of stainless steel or other suitable strong and rust-resistant material, including various plasticized materials.

The fishing reel mounting element 10 includes a central portion 16 and two opposing first and second end caps 12 and 14, respectively. The central portion 16 may be a tubular element, such as 3″-5″ pipe, with an interior diameter dimensioned to snugly slide on the outer circumference of a barrel 24 of a desired blowgun to be transformed. At the both ends of the central portion 16 pipe may be external circumferential threading 40.

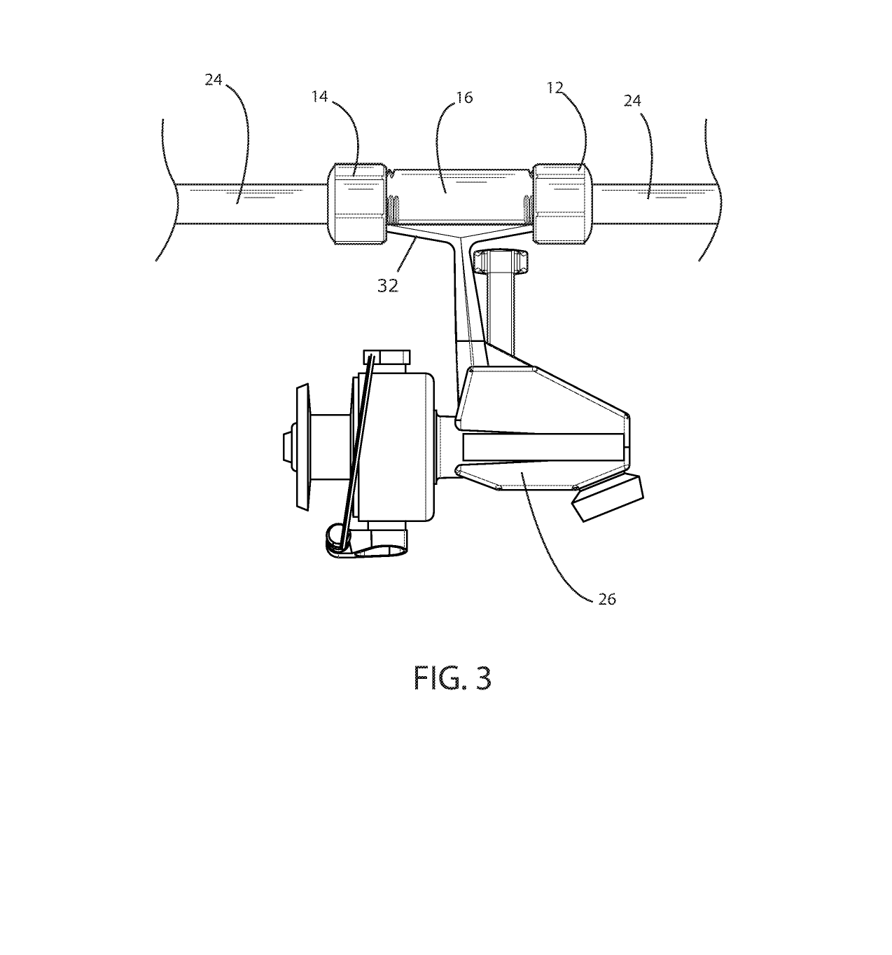

Each end cap 12, 14 provides a through hole 44 centrally disposed in a cap portion 46 thereof, wherein the interior diameter of the through hole 44 is generally coextensive with the interior diameter of the central portion 16 so as to also snugly slide on the outer circumference of said barrel 24. Each end cap 12, 14 provides inner circumferential threading 42 for mating to said threading 40 of the central portion 16. Thereby, each end cap 12, 14 can be screwed/fastened onto each opposing end of the threaded central portion 16 so as to wedge a reel foot 32 of a fishing reel 26 into a locked engagement with the central portion 16 and thus selectively connect the fishing reel 26 to the barrel 24 of the blowgun in a desired position there along, as illustrated in FIG. 3.

The central portion 16 may have a longitudinal cut 36 throughout it length facilitating compression onto the barrel 24 when the fishing reel 26 is secured via tightening the two end caps 12 and 14. The longitudinal cut 36 may provide a void within the circumferential wall of the central portion 16. The void may be five to ten percent of the circumferential wall. The longitudinal cut 36 may define a flat surface 38 for facilitating the locking engagement, wherein the flat surface 38 engages a portion of the reel foot 32. The fishing reel 26 can be re-positioned as needed by simply loosening the end caps 12 and 14 on the central portion 16 and then tightening them once the fishing reel 26 is in the proper position.

Once end caps 12 and 14 has secured the fishing reel 26 in the proper position, fishing reel 26 is aligned with the fishing line eye guide 18, 20 and 22, allowing the fishing line (not shown) to come off of the fishing reel 26 in the right direction (toward a distal end of the blowgun). To effectuate this, each fishing line eye guide 18, 20 and 22 provides opposing loops, a barrel loop 52 and a line loop 54 interconnected by a neck portion 56, as illustrated in FIG. 1. Each barrel loop 52 is adapted to removably connect to the blowgun barrel 24. In some embodiments, the barrel loop 52 may include two spaced apart loop portions 58 dimensioned so as to be bent in opposing directions to snugly match the outside diameter of the barrel 24 of the blowgun to be transformed. In another embodiment, the barrel loop 52 may provide a tension clamp 28, hose clamp 30, or the like (such as such as compression clamps, screw clamps, spring clamps, etc.) to selectively secure to said barrel 24. In some embodiments, the line loop 54 may include two spaced apart loop portions 58 that provide strength and reduced tangle risk.

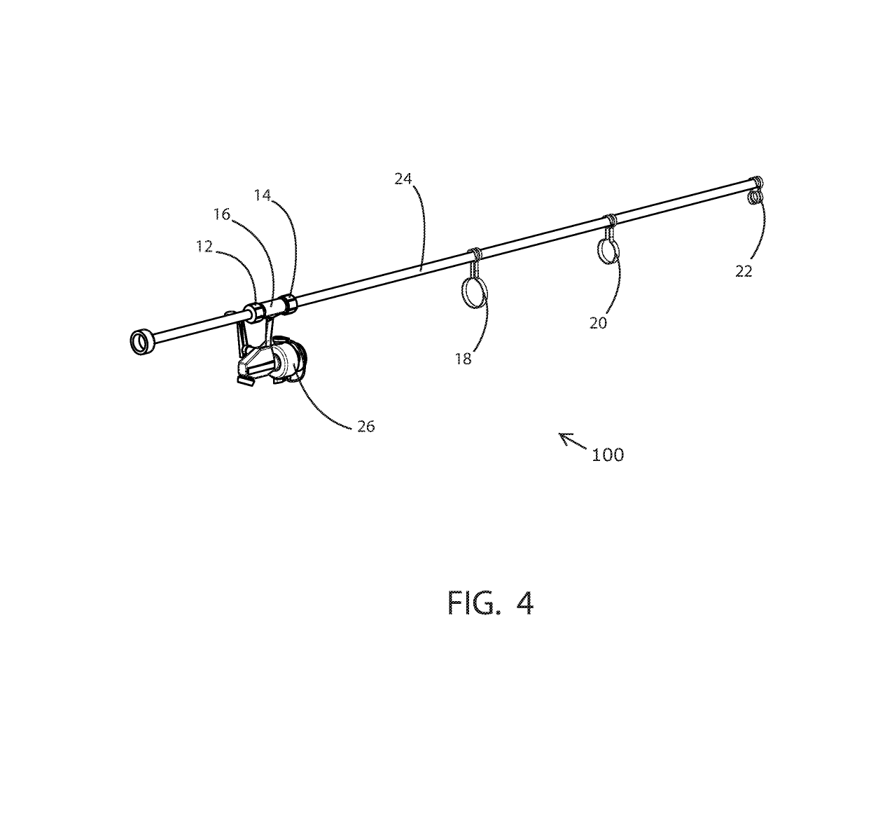

The line loop 54 is dimensioned and adapted as a loop/eye that functions as a guide for the fishing line to pass through. As mentioned above, the line loops 54 of the first, second, and third fishing line eye guides 18, 20, and 22 may have different diameters, the first line loop 54 being larger than the second, the second being larger than the third, wherein the first, second, and third fishing line eye guides 18, 20, and 22 are spaced apart along the barrel 24. Moreover, the first fishing line eye guide 18 is disposed nearest the central portion 16 and the third fishing line eye guide 22 being the furthest from the central portion 16, near or at the distal end of the barrel 24, as illustrated in FIG. 4.

In certain embodiments, the first neck portion 56 of the first fishing line eye guide 18 is approximately two inches in length and the line loop 54 has an eye that is approximately two inches in diameter; the second neck portion 56 of the second fishing line eye guide 20 is approximately one inch in length and the line loop 54 has an eye that is approximately one and one-half inches in diameter; and the third neck portion 56 of the third fishing line eye guide 22 is approximately zero inches in length and the line loop 54 has an eye that is approximately one inch in diameter, and may include two spaced apart loop portions 58 that provide strength and reduced tangle risk.

Once the line loops 54 of the first, second, and third fishing line eye guides 18, 20, and 22 have been placed in the proper position, they will be aligned, allowing the fishing line to flow through them. The first, second, and third fishing line eye guides 18, 20, and 22 can be re-positioned as needed by simply sliding them up or down the barrel 24. Once the fishing reel mounting element 10 and the first, second, and third fishing line eye guides 18, 20, and 22 are secured and aligned they will allow a water penetrating dart or standard blowgun dart, that is attached to said fishing line, to pull the fishing line off of the fishing reel and through the aligned line loops 54.

A method of manufacturing the present invention may include the following. A manufacturer may make the fishing reel mounting element 10 using an approximate 3″-5″ long×¾″ PVC pipe that has threads on both ends. Sand or drill out the interior diameter of the PVC pipe until it snugly slides on and off of the blowgun to be transformed. Mark the base of the fishing reel to be attached onto the pipe. Sand down a flat spot at the markings and ensure that the fishing reel base/foot 32 butts up flush on the flat spot. Make a ⅛″ cut longitudinally down the entire pipe right through the center of the flat spot. Acquire two threaded PVC nuts that match the pipe threads and thread one PVC nut on each end of the pipe.

For making the first, second, and third fishing line eye guides 18, 20, and 22, the manufacture could acquire an approximate 12″×0.2″×0.1″ piece of flat stainless-steel rod for each piece. For the first fishing line eye guide 18, the manufacturer may bend one end of the stainless-steel rod 270-360 degrees to snugly match the outside diameter of the blowgun which creates the blowgun loop, extend straight out 90 degrees from the blowgun loop 2″, bend an approximate 2″ line loop 54, come straight back to the blowgun 2″, match the first blowgun loop in opposing direction around the blowgun, and cut off the excess. For the second fishing line eye guides 20 repeat the same process with the difference of extending straight out 1″ from the barrel loop 52 and the line loop 54 being 1½″. For the third fishing line eye guide 22 repeat the same process with the difference of not extending straight out from the blowgun loop, the third line loop 54 being approximately one inch, having two spaced apart loop portions 58, and be as close to the blowgun as possible.

It is possible to use only one fishing line eye guides but this may reduce the effectiveness of managing and/or controlling the fishing line. The material type, dimensions, and shape of any parts could be changed to improve function, improve life span extension, accommodate for the size of the blowgun to be transformed, accommodate for the size of the fishing reel utilized, adjust for the type of prey that is sought after. All parts being machined instead of my hand made version could also improve function and accuracy. One or more fishing line eye guides could be added. More wraps for the line loop portions 54 may be added. The fishing line eye guides could be placed in different order but this may negatively affect the functionality.

A method of using the present invention may include the following. The blowgun adapter system 100 embodying the fishing reel mounting element 10, the first fishing line eye guide 18, the second fishing line eye guide 20, and the third fishing line eye guide 22 disclosed above may be provided. A user may move the fishing reel mounting element 10 into a selective locked engagement with the barrel 24 by tightening the end caps 12 and 14 as disclosed above after the reel foot 32 engages onto the flat spot on the central portion 16.

Then the user may connect the first fishing line eye guide 18, the second fishing line eye guide 20, and the third fishing line eye guide 22 along the barrel 24 as previously disclosed by sliding them onto the distal tip of the barrel 24. In certain embodiments, the first fishing line eye guide 18 may be positioned about 12″-18″ distally from fishing reel mounting element 10 while making sure it extends away from the blowgun in the same direction as the fishing reel 26. Then the second fishing line eye guide 20 is then similarly position approximately halfway between the first fishing line eye guide 18 and the distal tip of the barrel 24. Then the third fishing line eye guide 22 is connected to or adjacent to the distal tip of the barrel 24.

At this point the transformation of a blowgun into a fishing blowgun would be complete. The user now would be able to load/prepare the fishing blowgun by opening the bale of the fishing reel 26, stripping fishing line off of the fishing reel, running the fishing line through the fishing line eye guides 18, 20 and 22 attaching the fishing line to the back of a water penetrating dart or standard dart (not shown), back the dart down the barrel 24 of the blowgun until it is located just distally from the mouthpiece, and close the bale of the fishing reel. Once a fish is located in the water the user will open the bale of the fishing reel 26, take aim at the fish, blow into the blowgun, expel the dart out of the distal tip of the fishing blowgun, the dart will pull the fishing line behind it while it is flying through the air and toward the fish, the fishing line will coil off of the fishing reel, slide through the fishing line eye guides 18, 20 and 22, and follow the trajectory of the dart which it is attached to. The fish will be pierced in the water by the dart which has barbs, the bale of the fishing reel would be closed, and the fish would be brought/reeled in by turning the handle of the fishing reel. At this point the dart and fishing line would simply be traveling in the opposite direction of when they were expelled from the fishing blowgun and flying toward the fish. Once the fish is brought/reeled in the dart would be backed out of the fish and the fishing blowgun would be reloaded/prepared for the next shot by repeating the process as outlined above.

Additionally, the present invention could also be used to hunt animals that are not in the water. It could be beneficial if you shoot upwards with a dart because it would prevent the dart from being lost if you miss your shot because the dart would be attached to the fishing line and could be reeled back in. It could also be beneficial, with a barbed dart, to shoot an animal outside of the water which then could be prevented from escaping by using the attached fishing line, fishing blowgun adapter system, reel, and blowgun. This might allow for a secondary shot while the animal is prevented from escaping.

It should be understood, of course, that the foregoing relates to exemplary embodiments of the invention and that modifications may be made without departing from the spirit and scope of the invention as set forth in the following claims.

What is claimed is:

1. A fishing blowgun adapter system, comprising:
a reel mounting system for connecting a fishing reel to a blowgun in a locking engagement; and
a plurality of fishing line eye guides for attaching to the blowgun in a spaced apart arrangement there along.

2. The fishing blowgun adapter system of claim 1, wherein each fishing line eye guides extends between a barrel loop and a line loop, wherein each barrel loop removably attaches to the blowgun.

3. The fishing blowgun adapter system of claim 2, wherein each barrel loop provides a clamp.

4. The fishing blowgun adapter system of claim 2, wherein each fishing line eye guide provides a neck portion interconnecting the barrel loop to the line loop.

5. The fishing blowgun adapter system of claim 2, wherein the plurality of fishing line eye guides comprises a first fishing line eye guide, a second fishing line eye guide, and a third fishing line eye guide, wherein the first line loop of the first fishing line eye guide is larger in diameter than the second line loop of the second fishing line eye guide, and wherein the second line loop is larger in diameter than the third line loop of the third fishing line eye guide.

6. The fishing blowgun adapter system of claim 2, wherein each line loop of the plurality of fishing line eye guides has a different diameter.

7. The fishing blowgun adapter system of claim 4, wherein each neck portion of the plurality of fishing line eye guides has a different length.

8. The fishing blowgun adapter system of claim 6, wherein the plurality of fishing line eye guides is arranged from largest to smallest loop line diameter, respectively, extending from the reel mounting system to a distal end of the blowgun.

9. The fishing blowgun adapter system of claim 7, wherein the plurality of fishing line eye guides is arranged from largest to smallest neck portion length diameter, respectively, extending from the reel mounting system to a distal end of the blowgun.

10. The fishing blowgun adapter system of claim 1, the reel mounting system further comprising a central tubular portion and two opposing end caps.

11. The fishing blowgun adapter system of claim 10, wherein the central tubular portion provides exterior circumferential threading and the two end caps each provide interior circumferential threading dimensioned to mate with the exterior circumferential threading.

12. The fishing blowgun adapter system of claim 10, wherein each end cap provides a through hole coextensive with a lumen of the central tubular portion.

13. The fishing blowgun adapter system of claim 10, further comprising a longitudinal cut along a length of the central tubular portion.

14. The fishing blowgun adapter system of claim 10, wherein the longitudinal cut provides a flat surface for facilitating the locking engagement, wherein the flat surface engages a portion of the fishing reel.

15. The fishing blowgun adapter system of claim 9, wherein one of the neck portions has a length of zero.

16. A fishing blowgun adapter system, comprising:
a reel mounting system for connecting a fishing reel to a blowgun in a locking engagement;
the reel mounting system further comprising:
a central tubular portion and two opposing end caps, wherein the central tubular portion provides exterior circumferential threading and the two end caps ach provide interior circumferential threading dimensioned to mate with the exterior circumferential threading, and wherein each end cap provides a through hole coextensive with a lumen of the central tubular portion; and
a longitudinal cut along a length of the central tubular portion;
a first, a second, and a third fishing line eye guide for attaching to the blowgun in a spaced apart arrangement there along;
each fishing line eye guides includes a barrel loop and a line loop interconnected by a neck portion, wherein each barrel loop removably attaches to the blowgun, wherein each line loop has a different diameter, wherein each neck portion has a different length; and
the first, second, and third fishing line eye guides are attached along the blowgun from largest to smallest loop line diameter, respectively, and from largest to smallest neck portion length diameter, respectively, extending from the reel mounting system to a distal end of the blowgun.

17. The fishing blowgun adapter system of claim 16, wherein the longitudinal cut provides a flat surface for facilitating the locking engagement, wherein the flat surface engages a portion of the fishing reel.

18. The fishing blowgun adapter system of claim 16, wherein one of the neck portions has a length of zero.
